(19) United States
(12) Patent Application Publication
(10) Pub. No.: US 2010/0086710 A1
(43) Pub. Date: Apr. 8, 2010

(54) Hollow profile, particularly hollow profile sash bar, as well as a method and a device for its production

(76) Inventor: Joerg Engelmeyer, Wuppertal (DE)

Correspondence Address: COLLARD & ROE, P.C., 1077 NORTHERN BOULEVARD, ROSLYN, NY, 11576, US

(21) Appl. No.: 12/587,263

(22) Filed: Oct. 5, 2009

(30) Foreign Application Priority Data
Oct. 6, 2008 (DE) 10 2008 050 541.2

(51) Int. Cl. B32B 1/08; B21D 51/16

(52) U.S. Cl. 428/34.1; 29/897.3; 72/203

(57) ABSTRACT

A hollow profile welded in the longitudinal direction, in the region of two abutting edges, via a longitudinal weld seam, particularly a hollow profile sash bar for sash bars, made of metal, has a profile wall and an outer profile surface imprinted with paint. The longitudinal weld seam has an outer weld seam surface that does not project beyond the profile wall on the outside, and the outer weld seam surface is imprinted with paint.

### CROSS REFERENCE TO RELATED APPLICATIONS

Applicant claims priority under 35 U.S.C. §119 of German Application No. 10 2008 050 541.2 filed on Oct. 6, 2008.

### BACKGROUND OF THE INVENTION

1. Field of the Invention

The present invention relates to a hollow profile made of metal, particularly a hollow profile sash bar made of metal, preferably of aluminum, for insulated glazing, as well as to a method and a device for the production of the hollow profile.

2. The Prior Art

In insulated glazing, bars are disposed between two panes of glass of windows, for example. The bars are flat hollow profile rods that are usually interconnected by cross-connection pieces and are connected with the spacer frame of the insulated glazing using connection plugs. In this connection, the bars are preferably coated with paint, in order to adapt the color of the bars to the color of the window frames.

It is known to produce the sash bars by extrusion, as extruded hollow profiles, and subsequently to apply the desired paint by electrostatic powder coating. A disadvantage of this method is that the wall thickness of the extruded hollow profiles, at 0.6 mm to 0.8 mm, is relatively great because it is not possible to produce thin wall thickness values using the extrusion method. As a consequence, sash bars produced using the extrusion method are relatively heavy and expensive, because a lot of material is required. Furthermore, coating with the desired paint can take place only after profiling of the hollow profile extrudate. Furthermore, powder coating involves the problem that the field lines are concentrated at sharp edges. Frequently, over-coating of the work piece edges is the result. Also, a surface coated by powder coating is relatively uneven and a relatively large amount of paint is required.

Another method for the production of hollow profile sash bars is known from EP 0 577 150 B1. Production according to EP 0 577 150 B1 takes place by means of rolling deformation. In this connection, the desired paint is applied to a metallic flat band material using a roller printing system. Subsequently, the flat band material is cut into strips, and these strips are deformed by means of bending by rollers, until the two longitudinal edges of the strips abut one another. In this connection, a flat endless hollow profile rod is formed. The two abutting edges are subsequently welded to one another. It is advantageous in this method that profiles having a low wall thickness can be produced. Furthermore, clearly less paint is needed for the paint application than in the case of powder coating, and a smoother surface can be produced. The rolling and bending method, however, has the disadvantage that the paint comes off in the region of the weld seam, during welding, and that the weld seam is visible, which is unattractive. In order to overcome this disadvantage, EP 0 577 150 B1 discloses providing a profile retraction in the region of the weld seam after welding. The weld seam is provided in the region of the bottom of the profile retraction so that the weld seam is disposed so as to be optically covered.

Furthermore, it is known to produce hollow profile bars using the rolling and bending method, but without applying paint to the flat band material before rolling and bending. Instead, the finished, bent and profiled hollow profile bar is powder coated. The weld seam can be made invisible by subsequent coating using powder coating, in place of the imprinting application according to EP 0 577 150 B1. Powder coating, however, has the disadvantages mentioned above and is possible only in thick layers in order to achieve full coverage.

Furthermore, it is known, outside of sash bar production in the case of round pipes welded in the longitudinal direction, to scrape these pipes on the outside, in certain regions, in order to obtain a good surface. This scraping is done by means of a ring-shaped knife carrier head, which has three knife plates that are disposed uniformly distributed in the circumference direction of the knife carrier head, whereby the knife carrier head oscillates about its ring axis. The welded round pipe is moved through the knife carrier head, whereby one of the knives, in each instance, stands in engagement with the round pipe in such a manner that the outside of the round pipe is scraped off, in certain regions.

In summary, it should be stated that the method of EP 0 577 150 B1 is the one that has best proven itself, particularly due to the wall thickness of the profiles produced using this method, and the low amount of paint required for the paint application.

### SUMMARY OF THE INVENTION

It is therefore an object of the present invention to further develop the method of EP 0 577 150 B1 so that a cost-advantageous, simple, and efficient method for the production of hollow profiles made of metal, particularly of hollow profile sash bars for insulated glazing, is made available, with the hollow profile produced having the lowest possible wall thickness and a surface uniformly coated with paint.

Another object of the invention is to make available a device for cost-advantageous, simple, and efficient production of such hollow profiles made of metal for insulated glazing.

Another object of the present invention is to make available such a cost-advantageous and easy to produce hollow profile made of metal, particularly a hollow profile sash bar for sash bars for insulated glazing, which has the lowest possible wall thickness and a surface uniformly coated with paint.

In one aspect, these and other objects are achieved according to the invention by a hollow profile, particularly by a hollow profile sash bar for sash bars made of metal, welded together in the longitudinal direction, in the region of two abutting edges, by means of a longitudinal weld seam having a profile wall and an outer profile surface imprinted with paint, wherein the longitudinal wall seam has an outer weld seam that does not project beyond the profile wall on the outside, and the outer weld seam surface is imprinted with paint.

In another aspect, a device is provided according to the invention for production, particularly continuous production, of a hollow profile made of metal, particularly a hollow profile sash bar for sash bars, having a profile wall and an outer profile surface, particularly for the production of a hollow profile according to the first aspect of the invention above.

The device has a device for bending by rollers for producing a longitudinally slit endless hollow profile having two abutting edges that lie against one another, made from a metal strip coated with paint on at least one side, a welding device for producing a longitudinal weld seam by means of welding the two abutting edges to one another, and a profiling device for introducing profilings into the welded endless hollow profile to produce the hollow profile.

The device further includes a weld seam ablation device, particularly one disposed after the welding device and ahead of the profiling device, for externally ablating, particularly scraping off the longitudinal weld seam, to produce a smooth outer weld seam surface, and a paint application device, particularly following the profiling device, for imprinting the outer weld seam surface and preferably the adjacent region of the outer profile surface with paint, particularly in strip shape.

In a third aspect, a method is provided according to the invention for production, particularly continuous production, of a hollow profile made of metal, particularly a hollow-profile sash bar for sash bars, having a profile wall and an outer profile surface, particularly for the production of a hollow profile according to the first aspect of the invention above.

In accordance with the method, production takes place of a longitudinally slit endless hollow profile having two abutting edges that lie against one another from a metal strip coated with paint on at least one side by means of rolling deformation. Production of a longitudinal weld seam takes place by means of welding the two abutting edges to one another, and introduction of profilings into the welded hollow profile takes place to produce the hollow profile.

Also, in accordance with the method, the longitudinal weld seam is externally ablated, particularly scraped off, to produce a smooth outer weld seam surface, and the outer profile surface is coated, particularly in strip form, in the region of the outer weld seam surface and the adjacent regions, with paint by means of imprinting the paint.

Advantageous further aspects of the invention are discussed below.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a cross-sectional view of a hollow profile sash bar according to the invention;

FIG. 2 is a schematic perspective representation of the production of the hollow profile sash bar according to the invention from a broad metal band;

FIG. 3 shows a cross-section of a flat-oval endless hollow profile string welded in the longitudinal direction, before ablation of the weld seam, according to the invention, in other words with an elevated weld seam;

FIG. 4 is a schematic side view of the hollow profile string according to FIG. 3;

FIG. 5 is a schematic representation of a weld seam ablation device of the device according to the invention;

FIG. 6 is a schematic representation of a paint application device of the device according to the invention; and

FIG. 7. is a schematic front view of a window having insulated glazing.

### DETAILED DESCRIPTION OF PREFERRED EMBODIMENTS

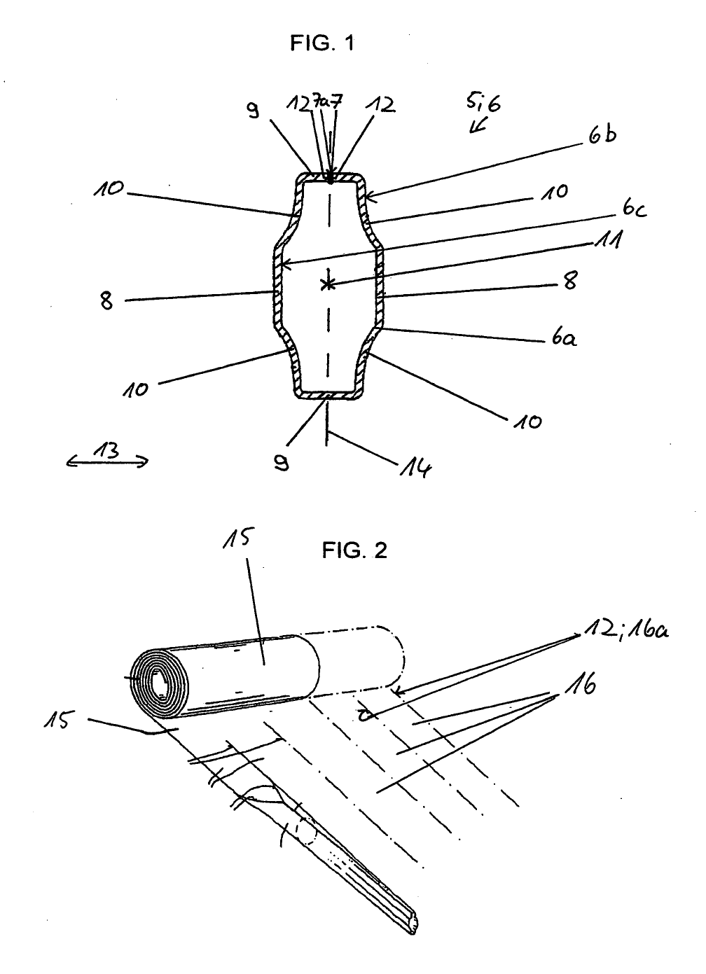

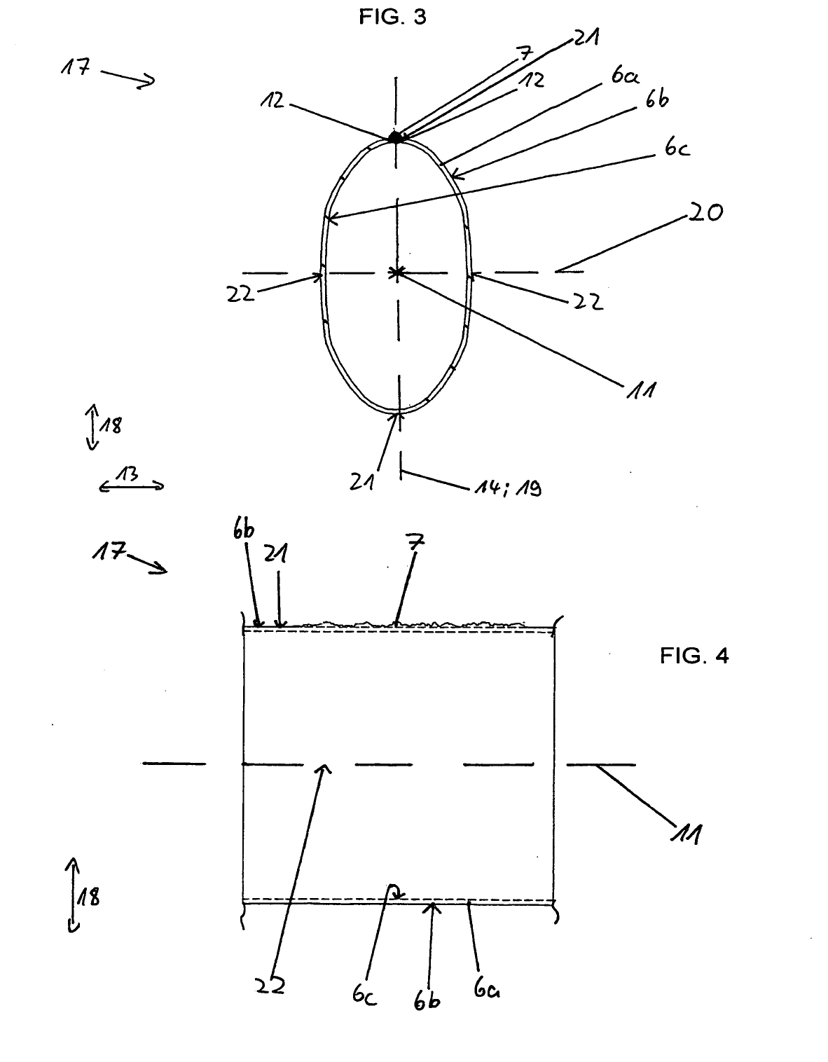

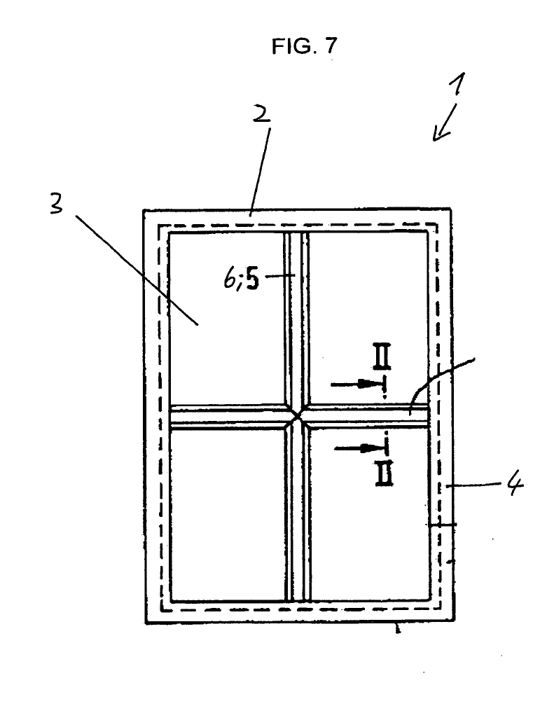

Turning now in detail to the drawings and in particular FIG. 7, a window 1 is shown having insulated glazing. Window 1 generally has a window frame 2, at least two glass panes 3 mounted in the window frame 2 and spaced apart from one another, and a spacer frame 4 that holds the glass panes 3 spaced apart from one another and is filled with desiccant. Sash bars 5 are disposed in the interstice between the glass panes 3. Sash bars 5 are hollow profile sash bars or hollow profile rods 6 made of metal, particularly aluminum, cut to the desired length, having a longitudinal weld seam 7 (FIGS. 1, 3, 4), which are combined to form an intersecting structure. At the intersection points, sash bars 5 are put together in known manner, using cross-connection pieces (not shown). Connection plugs are used, in known manner, to mount sash bars 5 on spacer frame 4.

Sash bars 5 can have different hollow profile cross-section shapes. A common hollow profile sash bar 6 (FIG. 1) has a profile wall 6a, as well as a hollow profile outer surface 6b and a hollow profile inner surface 6c. Profile wall 6a has side walls 8 disposed, for example, parallel to glass panes 3, and face walls 9 that preferably run crosswise, i.e. perpendicular to side walls 8, and extend in width direction 13 of hollow profile sash bar 6. In the region of side walls 8 and face walls 9, outer profile surface 6b is configured to be planar. Because the cross-section narrows from side walls 8 toward face walls 9, in other words the width of hollow profile sash bar 6 decreases, profile wall 6a furthermore has four transition walls 10. Transition walls 10 connect a side wall 8 with the next face wall 9, seen in the circumferential direction of hollow profile bar 6, in each instance. For this purpose, transition walls 10 are preferably configured in the shape of a cove, i.e. in concave shape when seen from the outside of hollow profile 6. Furthermore, hollow profile sash bar 6 has a longitudinal expanse in the direction of a longitudinal axis 11. Also, hollow profile sash bar 6 has two abutting edges, i.e. longitudinal edges 12, which extend parallel to longitudinal axis 11 and lie against one another, whereby the two abutting edges 12 are welded to one another by means of the longitudinal weld seam 7 that also extends parallel to longitudinal axis 11. Abutting edges 12 and longitudinal weld seam 7 are preferably provided in the region of one of two face walls 9. In particular, in this connection, the two abutting edges 12 and longitudinal weld seam 7 are disposed centered crosswise, with reference to the expanse of the corresponding face wall 9 in the width direction 13. It is practical if hollow profile sash bar 6 is configured to be symmetrical, overall, with reference to a center plane 14 that extends parallel to longitudinal axis 11 and perpendicular to the width direction 13.

In this connection, the production of hollow profile 6, particularly hollow profile sash bar 6 according to the invention, takes place in a method, preferably a continuous method, by means of rolling deformation and longitudinal welding, from a metallic flat band material, i.e. a metal band 15 (FIG. 2). For this purpose, first the relative broad metal band 15, which is wound up on a reel (not shown), for practical purposes, is drawn off this reel, passed through a paint coating device, and continuously coated with paint in this device, on one side. The coating process takes place, for example, by means of application of the paint by means of a known roller printing system having an application roller (not shown). In this connection, it is practical if the application roller consists of metal, or at least has an outer mantle made of metal.

After subsequent drying of the paint in a drying device through which the coated metal band 15 is passed continuously, for practical purposes, it is practical if the coated metal band 15 is wound up again, and then cut into multiple longitudinal strips 16 that lie parallel to one another. It is practical if this process is also done continuously, in a cutting device. Later, the longitudinal edges 16a on both sides of the metal strips 16 form the two abutting edges 12 that extend longitudinally.

In a known device for bending by rollers (not shown) that follows the cutting device, a metal strip 16, in each instance, is now continuously deformed into an endless hollow profile 17 having a longitudinal slit, in such a manner that the two abutting edges 12 abut one another, and the side of the metal strip 16 coated with paint forms the outer profile surface 6b. Rolling deformation takes place in known manner, using a pair of bending rollers (not shown) that are disposed one behind the other in a conveyance direction in which the metal strip 16 is conveyed. In this connection, the metal strip 16 is passed through between the two bending rollers of a bending roller pair, in each instance. In this connection, the one bending roller has a circumferential surface curved in concave manner, and the other bending roller has a circumferential surface curved in convex manner, whereby the circumference surfaces are coordinated with one another and the curvature increases from one pair of rollers to the next pair of rollers in such a way that the metal strip is gradually bent to form the longitudinally slit endless hollow profile 17.

It is practical if the endless hollow profile 17 has an essentially flat-oval, elliptical cross-section, whereby just like in the subsequent hollow profile sash bar 6, the expanse of the endless pipe 17 in the width direction 13 is already less than in the height direction 18. As a result, the main axis 19 of the elliptical cross-section is parallel to the height direction 18, and a secondary axis 20 is parallel to the width direction 13. The endless hollow profile 17 thus has two main zeniths 21 that lie opposite one another in the direction of the main axis 19, and two secondary zeniths 22 that lie opposite one another in the direction of the secondary axis 20. In this connection, the profile wall 6a is rounded off in the region of both zeniths 21, 22 but at least in the region of one, preferably both of the main zeniths 21, particularly configured in arc shape. In particular, the outer profile surface 6b has a radius of 2 mm to 4 mm, preferably 3 mm, in the main zeniths 21. The two main zeniths 21 furthermore demonstrate a greater curvature than the secondary zeniths 22. Also, the endless hollow profile 17 is furthermore preferably configured symmetrical to the center plane 14, and has a longitudinal expanse in the direction of the longitudinal axis 11. It is practical if the two abutting edges 12 and thus also the longitudinal weld seam 7 are furthermore disposed at one of the two main zeniths 21.

In a known welding device used in the device according to the invention (not shown), which follows the rolling and bending device, the two abutting edges 12 that abut one another are welded to one another by means of producing the longitudinal weld seam 7. Welding takes place, for example, by means of laser welding or induction welding.

Because, as has already been explained, the paint comes off outer profile surface 6b in the region around longitudinal weld seam 7, and weld seam 7 projects outward beyond profile wall 6a, it is provided, according to the invention, to ablate longitudinal weld seam 7 on the outside, so that the material of longitudinal weld seam 7 no longer projects outward beyond profile wall 6a, and outer profile surface 6b in this region is completely smooth and planar, and to subsequently coat the resulting paint-free region of outer profile surface 6b with paint.

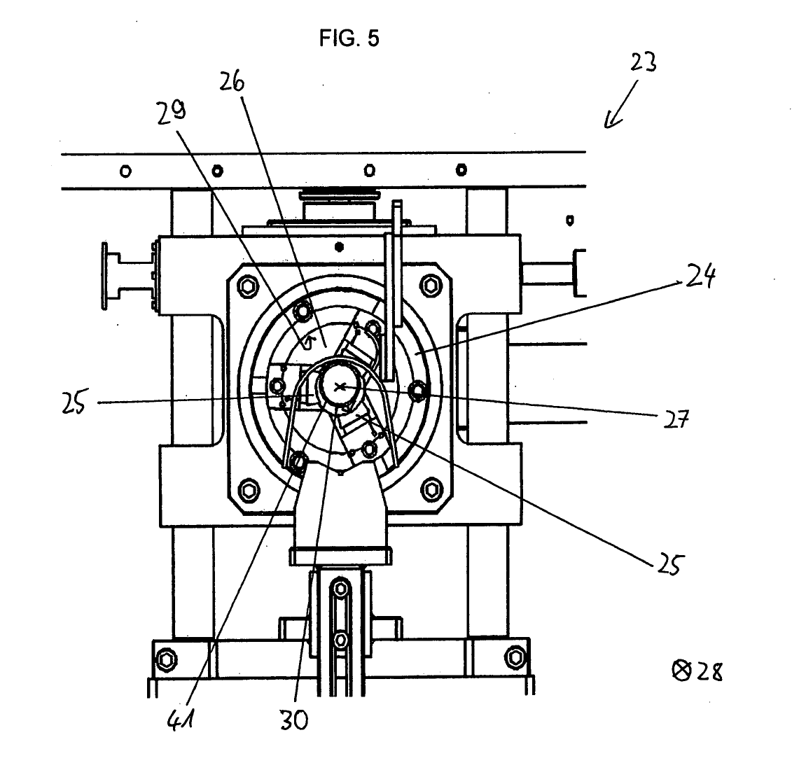

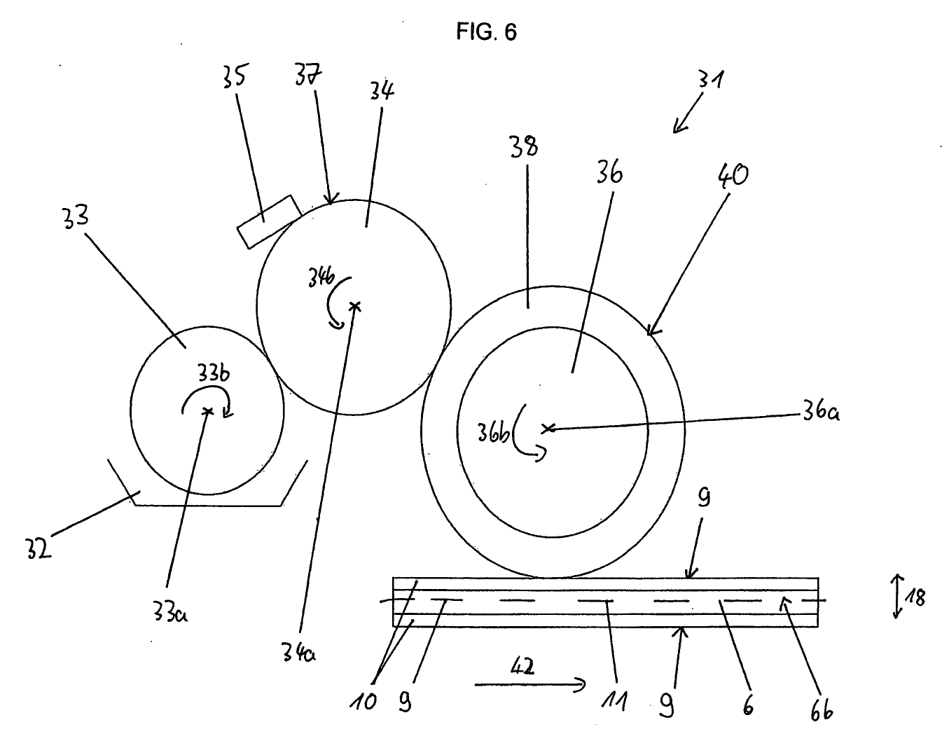

The weld seam ablation device 23 (FIG. 5) of the device according to the invention, which is provided for this purpose, has a blade holder 24 for holding at least one, preferably three blades 25 for scraping off longitudinal weld seam 7. Blade holder 24 is preferably configured in ring shape, and has a central, continuous opening 26 through which endless hollow profile 17 (in FIG. 5, a round pipe 41 is shown instead) is passed to scrape the longitudinal weld seam 7 off. Furthermore, blade holder 24 has a preferably central axis of rotation 27, which is preferably parallel to a transport direction 28 in which the endless hollow profile 17 is transported, i.e. moved through the opening 26 by means of suitable transport means. In this connection, the transport direction 28 is parallel to the longitudinal axis 11 of the endless hollow profile 17. The entire blade holder 24 and thus the blades 25 can be driven to oscillate and rotate about the axis of rotation 27. In this connection, it is practical if the oscillation angle, in other words the angle that the blade holder 24 covers in one direction, amounts to 5° to 25°, preferably 10° to 15°. Furthermore, it is practical if the blade holder 24 performs 5 to 60, preferably 20 to 40, back and forth movements per minute.

The three blades 25 are disposed distributed around the opening 26, whereby they project into the opening 26, radially with reference to the axis of rotation 27, in other words project beyond an opening wall surface 29 that, delimits the opening 26 radially toward the inside, so that the longitudinal weld seam 7 can be scraped off by means of the blades 25. In this connection, the three blades 25 are preferably disposed uniformly distributed about the axis of rotation 27, in other words seen in the circumferential direction of the opening 26. Furthermore, the blades 25 preferably have an identical spatial shape. In this connection, it is practical if a blade cutting edge 30 has a concave progression, particularly an arc-shaped, concave progression curved around the axis of rotation 27. Furthermore, the blade cutting edge 30 preferably extends in a plane perpendicular to the transport direction 28.

In order to scrape off the longitudinal weld seam 7, one of the blades 25 is always disposed in such a manner that it stands in engagement with the endless hollow profile 17, while this profile 17 is being passed through the opening 26. In particular, the endless profile 17 is passed through the opening 26 in such a manner that the longitudinal weld seam 7 faces upward, so that the top blade 25 is always in engagement with the endless hollow profile 17. Because the endless hollow profile 17 performs a movement relative to the blade 25 in the transport direction 28 as it passes by the blade 25, and the blade 25, at the same time, performs a movement relative to the endless hollow profile 17, perpendicular to the transport direction 28, because of the rotational movement about the axis of rotation 27, the longitudinal weld seam 7 is cut off, i.e. scraped off from the endless hollow profile 17 on the outside, in other words starting from the outer profile surface 6b, by means of a drawing cut. In this connection, the longitudinal weld seam 7 is ablated.

In order to adapt the height of the blade 25 that is in engagement, in each instance, to the height of the endless profile 17, the blade holder 24 is preferably adjustable in height. The height of the blade 25 has to be set in such a way that the longitudinal weld seam 7 is scraped off to such an extent that the longitudinal weld seam 7 no longer projects beyond the profile wall 6 on the outside, and that a smooth outer weld seam surface 7a (FIG. 1) is formed, but the profile wall 6 is scraped off only to a slight degree. The outer weld seam surface 7a of the ablated weld seam 7 preferably has a roughness Ra of 0.152 to 0.550 μm, preferably 0.250 μm, and a roughness Rz of 0.85 to 3.1 μm, preferably 2.7 μm. This result also requires a corresponding adaptation of the blade arrangement and the shape of the blade cutting edge 30. The roughness values indicated were determined over the length (parallel to the longitudinal axis 11).

The weld seam ablation device 23 is followed by a known profiling device (not shown) used in the device according to the invention in which the endless hollow profile 17, which has been welded in the longitudinal direction, is profiled in such a manner that it is given the desired cross-section shape, i.e. the cross-section shape described above, of the hollow profile sash bar 6 to be produced. For this purpose, it is practical if the profiling device has multiple profiling rollers, in known manner. In particular, the endless hollow profile 17 is profiled in such a manner that the two main zeniths 21 are flattened in order to form the face walls 9, and the two secondary zeniths 22 are flattened to form the side walls 8. Furthermore, the concave transition walls 10 are pressed in.

According to the invention, the hollow profile sash bar 6 is now subsequently coated with paint, once again, after profiling, as already explained above, specifically only in a strip-shaped paint-free region on the longitudinal weld seam 7 and around the longitudinal weld seam 7, where the paint came off during welding. This strip-shaped, paint-free, planar region consequently lies on the face wall 9 that has the longitudinal weld seam 7.

For this purpose, a paint application device 31 of the device according to the invention follows the profiling device. The paint application device 31 has a paint container 32 containing the paint to be applied, a paint pick-up roller 33 for picking the paint up from the paint container and transferring the paint to a stencil roller 34, a squeegee device 35 for stripping off excess paint from the stencil roller 34, and an application roller 36 for applying the paint to the hollow profile sash bar 6.

In this connection, the hollow profile sash bar 6 is passed through the paint application device 31 in a transport direction 42 that preferably lies parallel to the longitudinal axis 11 and the transport direction 28. The paint pick-up roller 33 can be driven to rotate about an axis of rotation 33a that is preferably perpendicular to the transport direction 42, preferably horizontal, in a direction of rotation 33b, and is disposed in such a manner that it is immersed into the paint container 32 and thereby picks up paint. The stencil roller 34 can also be driven to rotate about an axis of rotation that is perpendicular to the transport direction 42, preferably horizontal, but in the opposite direction of rotation 34b relative to the paint pick-up roller 33. In this connection, the paint pick-up roller 33 and the stencil roller 34 roll on one another in such a manner that the paint picked up by the paint pick-up roller 33 is transferred to the stencil roller 34.

The stencil roller 34 furthermore has at least one groove (not shown) in its circumference surface 37, which groove runs in the circumference direction. The groove establishes the amount of paint and the width of the paint strip that is applied to the hollow profile sash bar 6.

For this purpose, the excess paint is stripped from the circumference surface 37 by means of the squeegee device 35, so that only the paint in the groove remains on the circumference surface 37. It is practical if the groove has a depth, in other words a radial expanse, of 0.1 mm to 0.3 mm, preferably 0.15 mm to 0.2 mm. Furthermore, it is practical if the groove has a width, in other words an expanse parallel to the axis of rotation 34a, of 2 mm to 4 mm, preferably 2.5 mm to 3 mm. This paint that remains in the groove is then transferred from the stencil roller 34 onto the application roller 36, for which purpose the stencil roller 34 and the application roller 36 roll on one another.

The application roller 36 can also be driven to rotate about an axis of rotation 36a that is perpendicular to the transport direction 42, preferably horizontal, but in the opposite direction of rotation 36b relative to the stencil roller 34. According to a preferred embodiment of the invention, the application roller 36 furthermore has a mantle wall 38 that consists of rubber. In particular, the mantle wall 38 consists of silicone rubber or PU (polyurethane). Furthermore, the material of the mantle wall 38 preferably has a hardness of 20 to 80 Shore-A, preferably 70 to 80 Shore-A.

The particular advantage of the mantle wall 38 made of rubber as compared with a mantle wall made of metal, particularly steel, lies in the different degrees of hardness that can be used, and in the function of balancing out slight depressions in the material to be imprinted.

The paint is transferred to the application roller 36 in such a manner that the application roller 36 has a paint strip having a predetermined width, in other words an expanse parallel to the axis of rotation 36a of the application roller 36, on its smooth, non-profiled circumference surface 40. This paint strip is applied, particularly imprinted, by means of the application roller 36 and from it onto the hollow profile bar 6. For this purpose, the hollow profile bar 6 is guided past the application roller 36 with the face wall 9 that has the longitudinal weld seam 7 facing the application roller 36, particularly guided through with the corresponding face wall 9 facing upward, underneath the roller. In this connection, the application roller 36 rolls on the corresponding face wall 9, whereby it exerts a predetermined pressure on this wall 9, so that the paint is imprinted in strip form, from the application roller 36 onto the outer weld seam surface 7a and the outer profile surface 6b adjacent to the outer weld seam surface 7a. In this connection, the hollow profile sash bar 6 is supported, in suitable manner, by means of corresponding counter-pressure means (not shown).

In this connection, the paint strip that is imprinted onto the face wall 9 by means of the application roller is dimensioned, in terms of width, such that it covers the outer weld seam surface 7a and the region of the outer profile surface 6b from which the paint that was previously applied came off during welding. In this way, a closed paint layer is formed on the entire outer profile surface 6b of the hollow profile bar 6. In this connection, the amount of the paint applied by means of the application roller 36 and thus the coating thickness is particularly determined by the depth of the groove. For practical purposes, this depth is established in such a manner that the coating thickness in the region of the paint strip essentially corresponds to the coating thickness in the region of the remainder of the profile wall 6. In this way, a homogeneous coating thickness over the entire outer profile surface 6b is guaranteed, thereby resulting in uniform coloring.

It is practical if the device according to the invention furthermore has a device for cutting the endless hollow profile sash bar 6 into hollow profile sash bars 6 having a predetermined length, for example for use as a sash bar 5.

In the method according to the invention, it is advantageous that hollow profiles 6 of any type, having a very slight wall thickness, can be produced by means of rolling deformation. The wall thickness of the hollow profile sash bar 6 that is produced preferably amounts to 0.35 mm to 0.4 mm, preferably 0.37 mm to 0.4 mm. In this way, tremendous material costs are saved in comparison with production by means of extrusion. Furthermore, the hollow profile bar 6 produced according to the invention has a homogeneous paint coating on its entire outer profile surface 6b. In this connection, coating has taken place, in all regions, by means of imprinting the paint, i.e. printing with paint. In this coating method, significantly less paint is required than in powder-coating, and this savings in paint in turn saves costs. Furthermore, a clearly smoother surface is obtained. Because of the high material costs, the method according to the invention is cost-effective despite the two additional method steps.

In this connection, it was discovered, within the scope of the invention, that ablation of the weld seam by means of the drawing cut, in particular, using suitable means, especially the oscillating blade 25, is particularly advantageous because this process yields a sufficiently smooth outer weld seam surface 7a in a single work step with damp cleaning, without any subsequent machining, to which the imprinted paint permanently adheres. Even during profiling of the endless hollow profile 17, the weld seam 7 no longer bulges up, so that the planar outer weld seam surface 7a is maintained. This result was not easily predictable. As a result, a particularly advantageous selection was made to the effect that ablation already takes place ahead of profiling.

Furthermore, the hollow profile sash bar 6 according to the invention does not have any profile retractions that could be disruptive when connecting multiple profiles with one another by inserting them into one another.

Of course, it also lies within the scope of the invention to first wind up the metal band 15 after coating it with paint and subsequently drying it, and to process it further later, or to cut it into the metal strips 16 and first wind these up. These alternatives can also take place in devices specifically provided for this purpose, separate from the device according to the invention. Alternatively, metal strips 16, particularly pre-finished metal strips, can be used, and these strips can be directly coated with paint.

Furthermore, the production process as a whole or the individual steps can also take place discontinuously.

Although only a few embodiments of the present invention have been shown and described, it is to be understood that many changes and modifications may be made thereunto without departing from the spirit and scope of the invention.

What is claimed is:

1. A hollow profile comprising:
(a) first and second longitudinal abutting edges welded together with a longitudinal weld seam;
(b) a profile wall; and
(c) an outer profile surface imprinted with paint;
wherein the longitudinal weld seam has an outer weld seam surface that does not project exteriorly beyond the profile wall; and
wherein the outer weld seam surface is imprinted with paint.

2. The hollow profile according to claim 1, wherein the hollow profile is a hollow profile sash bar for sash bars.

3. The hollow profile according to claim 1, wherein the profile wall has first and second side walls disposed parallel to one another, and first and second face walls that run crosswise to the side walls.

4. The hollow profile according to claim 3, wherein the cross-section of the side walls narrows toward the face walls, and the profile wall has first, second, third and fourth transition walls respectively connecting a side wall with a face wall next to said side wall in the circumferential direction of the hollow profile.

5. The hollow profile according to claim 1, wherein the hollow profile extends longitudinally along a longitudinal axis.

6. The hollow profile according to claim 3, wherein the longitudinal weld seam is provided in a region of one of the first and second face walls.

7. The hollow profile according to claim 6, wherein the longitudinal weld seam is disposed centered in a width direction of the first face wall.

8. A device for production of a hollow profile made of metal having a profile wall and an outer profile surface comprising:
(a) a device for bending by rollers for producing a longitudinally slit endless hollow profile having two abutting edges that lie against one another and being made from a metal strip coated with paint on at least one side of the metal strip;
(b) a welding device for producing a longitudinal weld seam by welding the two abutting edges to one another;
(c) a profiling device for introducing profilings into the endless hollow profile following welding;
(d) a weld seam ablation device for externally ablating the longitudinal weld seam to produce a smooth outer weld seam surface; and
(e) a paint application device for imprinting the outer weld seam surface with paint.

9. The device according to claim 8, wherein the ablation device is disposed after the welding device and before the profiling device.

10. The device according to claim 8, wherein the paint application device is disposed after the profiling device.

11. The device according to claim 8, wherein the weld seam ablation device is configured to scrape off the longitudinal weld seam.

12. The device according to claim 8, further comprising a paint coating device for imprinting paint onto the metal strip or onto a metal band, the metal strip being formed from cutting of the metal band.

13. The device according to claim 11, wherein the weld seam ablation device has a blade holder for holding at least one blade for scraping off the longitudinal weld seam.

14. The device according to claim 13, wherein the blade holder has a ring shape and a central continuous opening for scraping off the longitudinal weld seam by passing the endless hollow profile through the central continuous opening using a transport device.

15. The device according to claim 13, wherein the at least one blade with the blade holder can be driven to rotate and oscillate about an axis of rotation.

16. The device according to claim 15, wherein the at least one blade with the blade holder can be driven in one direction, around an oscillation angle of 5° to 25°.

17. The device according to claim 15, wherein the at least one blade with the blade holder can be driven at 5 to 60 back and forth movements per minute.

18. The device according to claim 15, wherein the blade holder holds three blades uniformly distributed about the axis of rotation.

19. The device according to claim 15, wherein the at least one blade comprises a blade cutting edge having a concave, arc-shaped progression, curved about the axis of rotation, the blade cutting edge extending in a plane perpendicular to a transport direction.

20. The device according to claim 7, wherein the paint application device has an application roller for applying the paint to the hollow profile, said application roller being drivable to rotate about an axis of rotation.

21. The device according to claim 20, wherein the application roller has a mantle wall made of rubber.

22. The device according to claim 21, wherein the application roller has a mantle wall made of silicone rubber or polyurethane (PU).

23. The device according to claim 21, wherein the mantle wall is made from a material having a hardness of 20 to 80 Shore-A.

24. The device according to claim 20, wherein the paint application device has a stencil roller for transferring to the application roller the paint to be imprinted onto the hollow profile.

25. The device according to claim 24, wherein the stencil roller is configured to transfer a paint strip to be imprinted onto the hollow profile to the application roller.

26. The device according to claim 25, wherein the stencil roller has at least one groove on a circumferential surface of a stencil roller running in the circumferential direction for holding the paint to be imprinted onto the hollow profile.

27. The device according to claim 26, wherein the stencil roller has a stencil roller axis of rotation and the groove has a radial expanse of 0.1 mm to 0.3 mm.

28. The device according to claim 26, wherein the stencil roller has a stencil roller axis of rotation and the groove has an expanse parallel to the stencil roller axis of rotation of 2 mm to 4 mm.

29. A method for producing a hollow profile made of metal having a profile wall and an outer profile surface comprising the following steps:
(a) subjecting a metal strip coated with paint on at least one side to rolling deformation to produce a longitudinally slit endless hollow profile having two abutting edges that lie against one another;
(b) producing a longitudinal weld seam by welding the two abutting edges to one another;
(c) introducing profiling into the endless hollow profile following welding;
(d) externally ablating the longitudinal weld seam to produce a smooth outer weld seam surface; and
(e) coating via imprinting with paint the outer profile surface in a region of the outer weld seam surface.

30. The method according to claim 29, wherein a hollow profile sash bar for sash bars is produced.

31. The method according to claim 29, wherein also regions adjacent to the outer weld seam surface are imprinted with paint.

32. The method according to claim 29, wherein the endless hollow profile produced has a flat-oval, elliptical cross-section.

33. The method according to claim 29, wherein the longitudinal weld seam is externally ablated using a drawing cut to scrape off the longitudinal weld seam.

34. The method according to claim 31, wherein the endless hollow profile is profiled so that the longitudinal weld seam and a region of the outer profile surface adjacent to the longitudinal weld seam to be imprinted with paint are planar.

35. The method according to claim 29, wherein the endless hollow profile is an endless pipe and the longitudinal weld seam is ablated from the endless pipe before profiling.

36. The method according to claim 29, wherein the paint is applied to the hollow profile after profiling.

37. The method according to claim 29, wherein the longitudinal weld seam is ablated so that the longitudinal weld seam no longer projects outward beyond the profile wall.

38. The method according to claim 29, wherein the metal strip is cut from a metal band before rolling deformation takes place.

39. The method according to claim 29, wherein the metal strip is imprinted with paint on at least one side before rolling deformation takes place.

40. The method according to claim 29, wherein the metal strip is deformed into the longitudinally slit endless hollow profile so that a side of the metal strip coated with paint forms the outer profile surface.

41. The method according to claim 29, wherein the endless hollow profile produced has a main axis and a secondary axis perpendicular to the main axis and has two main zeniths that lie opposite one another in a direction of the main axis and two secondary zeniths that lie opposite one another in a direction of the secondary axis.

42. The method according to claim 41, wherein the endless hollow profile produced has a profile wall configured to be rounded off in a region of at least one main zenith.

43. The method according to claim 41, wherein the endless hollow profile produced has the longitudinal weld seam disposed on one of the two main zeniths.

44. The method according to claim 29, wherein a weld seam ablation device is used for externally ablating the longitudinal weld seam to produce a smooth outer weld seam surface.

45. The method according to claim 44, wherein the weld seam ablation device has a blade holder holding at least one blade standing in engagement with the endless hollow profile at all times, scraping the endless hollow profile, and the endless hollow profile performs a movement relative to the blade in a direction parallel to the longitudinal axis of the endless hollow profile as the endless hollow profile passes by the blade, and the blade, at the same time, performs a movement relative to the endless hollow profile, in a direction perpendicular to the longitudinal axis, because of an oscillating rotational movement about an axis of rotation.

46. The method according to claim 45, wherein the blade holder and the at least one blade oscillate about an oscillation angle of 5° to 25°.

47. The method according to claim 45, wherein the blade holder and the at least one blade perform 5 to 60 back and forth movements per minute.

48. The method according to claim 41, wherein the endless hollow profile is profiled so that the two main zeniths are flattened in order to form face walls of the endless hollow profile and the two secondary zeniths are flattened to form side walls of the endless hollow profile.

49. The method according to claim 41, wherein the endless hollow profile is profiled so that the hollow profile has a straight face wall and the longitudinal weld seam is disposed in a region of the straight face wall.

50. The method according to claim 29, wherein a paint application device having an application roller driven to rotate about an axis of rotation is used to apply the paint onto the hollow profile.

51. The method according to claim 50, wherein the paint is imprinted onto the outer weld seam surface and the adjacent outer profile surface using the application roller.

52. The method according to claim 51, wherein the application roller rolls and exerts a pressure on the outer weld seam surface and on the adjacent outer profile surface.
